(19) United States
(12) Patent Application Publication
(10) Pub. No.: US 2005/0002642 A1
(43) Pub. Date: Jan. 6, 2005

(54) Dynamic buffer control for real-time system

(76) Inventors: Yusuke Minagawa, Tsukuba (JP); Tomoyuki Naito, Tsukuba (JP); Satoru Yamauchi, Tsuchiura (JP)

Correspondence Address: TEXAS INSTRUMENTS INCORPORATED, P O BOX 655474, M/S 3999, DALLAS, TX, 75265, US

(21) Appl. No.: 10/838,916

(22) Filed: May 3, 2004

Related U.S. Application Data
(60) Provisional application No. 60/466,969, filed on May 1, 2003.

(51) Int. Cl. G11B 7/085

(52) U.S. Cl. 386/49; 386/96

(57) ABSTRACT

This invention controls a system that simultaneously processes video and audio data in real time having read and write track buffers. The invention detects a specific state at one of the storage devices that generates a long delay for communication. Upon this detection, the invention dynamically allocating a fixed amount of memory to read and write track buffers. The storage devices include a first storage device having a long delay caused by mechanical performance, such as a DVD read/write drive and a second storage device not having a long delay caused by mechanical performance such as a hard disk drive.

### CLAIM OF PRIORITY

This application claims priority under 35 U.S.C. 119(e)(1) from U.S. Provisional Patent Application No. 60/466,969 filed May 1, 2003.

### TECHNICAL FIELD OF THE INVENTION

The technical field of this invention is dynamic control of the sizes of the track buffers that interface with connected storage devices on real-time system.

### BACKGROUND OF THE INVENTION

In a system that simultaneously processes video and audio data in real time such as a DVD/HDD hybrid recorder, a temporary memory called a track buffer is allocated between the storage devices and the system main processor. There are two track buffers: a reading track buffer; and a writing track buffer. The reading-track buffer stores data transferred from storage devices such as ATA/ATAPI. The writing track buffer stores data to be transferred to these devices. These track buffers store the data from/to the storage devices so that the system does not break down if a storage device generates a long waiting time when the system cannot access the storage device. A longer waiting time needs a larger track buffer.

In current consumer DVD/HDD hybrid recording systems, the interfaces between the main processor and the storage devices are constructed one-to-one (called dual-bus solution) in order to avoid system break down. Additionally, the dual-bus solution provides easy architecture design. The sizes of the track buffers are fixed by specification of the storage devices connected to the system.

FIG. 1 illustrates this dual-bus system. The heart of the system is MPEG codec LSI (large scale integrated circuit) 100. MPEG codec LSI 100 receives an input from a television signal source such as antenna 110 and receiver 115 for capturing a broadcast signal. This input signal is encoded by MPEP encoder 120. The encoded signal is temporarily stored in track buffer 131. In the example illustrated in FIG. 1, track buffer 131 serves as a write buffer for first storage device 141 via interface 143. The example of FIG. 1 illustrates reading second storage device 145 via interface 147 and track buffer 135 serving as a read buffer. The read data, which has been previously MPEG encoded is decoded by MPEG decoder 140. The decoded signal is displayed via display 150. Because this interface including interfaces 143 and 147 needs as many as 32 external pins, this dual-bus solution makes further reduction of chip size and large scale integration (LSI) difficult.

Taking this into consideration, the trend is to a single interface architecture (called single-bus solution) for dual storage devices. FIG. 2 illustrates this single-bus solution. FIG. 2 is similar to FIG. 1 except for the external interfaces to the first and second storage devices. FIG. 2 shows a single interface 147 connecting first track buffer 131, second track buffer 135, first storage device 141 and second storage device 145.

In the single-bus solution, data communication to any storage devices is affected by the performance of other connected storage devices because multiple storage devices share one system interface 147. If this interference occurs during recording, the amount of data stored in write track buffer grows larger. On the other hand, if it occurs during playback, the amount of data stored in read track buffer becomes smaller. In both cases the system risks track buffer breakdown. Therefore, just as for the dual-bus solution, a large track buffer is needed to avoid system breakdown.

A large track buffer provides high robustness of system performance. This permits stable and continuous data communication for both recording and playback. A large track buffer also causes proportional delay on simultaneous recording and playback on a hard disk drive (HDD3). The larger the track buffer, the greater the delay time. This phenomenon may is weak point for system real-time performance in a DVD/HDD hybrid recording system. On the contrary, a small size track buffer provides us enough memory area for other usages. However selecting large track buffers creates long waiting time and data communication is impossible during the waiting time. Too long waiting time causes system breakdown.

### SUMMARY OF THE INVENTION

For general storage devices such as ATA/ATAPI, only specific commands and the transitions generate a long waiting time during which data communication with the storage device is impossible. Once the amount of data stored in a write track buffer reaches its maximum or the amount of data stored in read track buffer reaches its minimum, system breakdown occurs. However, stored data in the track buffers seldom reaches both these limitation values even for simultaneous recording and playback. The track buffers have redundant area for most cases. Thus size optimization of the track buffers is possible if the specific cases and the state transitions that generate long wait times are addressed. In spite of this, no prior method dynamically controls the size of the track buffer because of incomplete comprehension of the performance of the storage devices.

This invention controls a system that simultaneously processes video and audio data in real time having read and write track buffers. The invention detects a specific state at one of the storage devices that generates a long delay for communication. Upon this detection, the invention dynamically allocating a fixed amount of memory to read and write track buffers. The storage devices include a first storage device having a long delay caused by mechanical performance, such as a DVD read/write drive and a second storage device not having a long delay caused by mechanical performance such as a hard disk drive.

On detecting insertion of a DVD into a DVD drive for playback, this invention increases the size of the write track buffer and decreases the size of the read track buffer. Following a read initiation interval at the DVD drive, the invention transfers data in the write track buffer to the hard disk drive. The invention re-allocates the memory to the read and write track buffers in fixed initialization amounts thereafter.

On detecting insertion of a DVD into a DVD drive for recording, this invention increases the size of the read track buffer and decreases the size of the write track buffer. Following a record initiation interval at the DVD drive, the invention transfers data in the read track buffer to the DVD drive. The invention re-allocates the memory to the read and write track buffers in fixed initialization amounts thereafter.

### BRIEF DESCRIPTION OF THE DRAWINGS

These and other aspects of this invention are illustrated in the drawings, in which:

FIG. 1 illustrates a simplified block diagram of a prior art hybrid DVD/HDD recorder using a dual-bus solution;

FIG. 2 illustrates a simplified block diagram of a prior art hybrid DVD/HDD recorder using a single-bus solution;

FIG. 3 illustrates a block diagram of the hardware of one embodiment of this invention;

FIG. 4 illustrates a flow chart of the method of this invention for DVD insertion for playback;

FIG. 5 illustrates schematically the change in buffer allocation for the method illustrated in FIG. 4;

FIG. 6 illustrates a flow chart of the method of this invention for DVD insertion for recording; and

FIG. 7 illustrates schematically the change in buffer allocation for the method illustrated in FIG. 6.

### DETAILED DESCRIPTION OF PREFERRED EMBODIMENTS

In this invention, the host processor dynamically controls the size of the read and write interface buffers. This permits effective use of a single bus architecture for dual storage devices on a real-time system. The host processor dynamically controls the size of the read and write track buffers in the specific cases that result in a long waiting time during which the system cannot communicate with the storage devices.

This invention is useful in a real-time system having both a DVD drive and a HDD. These specific cases are limited to these initial sequences:
(1) Reading a DVD after disc insertion
   (a) Reading a DVD-Video disc, the initial sequence including CSS detection and MKB process;
   (b) Reading DVD-RW disc with CPRM;
   (c) Reading a defective DVD-RW disc with CPRM;
(2) Writing a DVD after disc insertion
   (a) Writing DVD RW disc, the initial sequence such as optical power calibration; and
   (b) Writing a DVD-RW disc with CPRM.
      In other words, the amount of data stored in the track buffer for reading or writing seldom overflows or underflows except in these cases.

The case that generates the longest waiting time is the initial sequence of reading for DVD playback, especially for a defective disc. As the spindle rotation speed of the DVD drive changes throughout this initial sequence, the host processor stalls data communication to the drive to stabilize of the rotation speed and data detection. This takes around 4 seconds for normal discs and around 6 seconds for defective discs. Data communication with the storage device is impossible for this time. The host processor has to store up to 6 seconds of data for playback or recording in a track buffer.

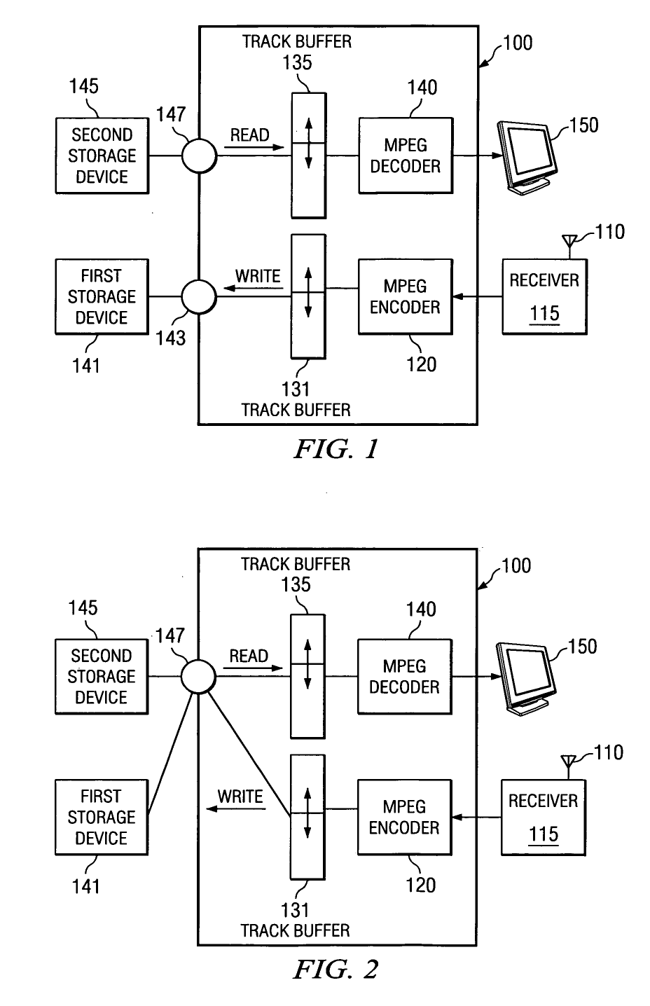

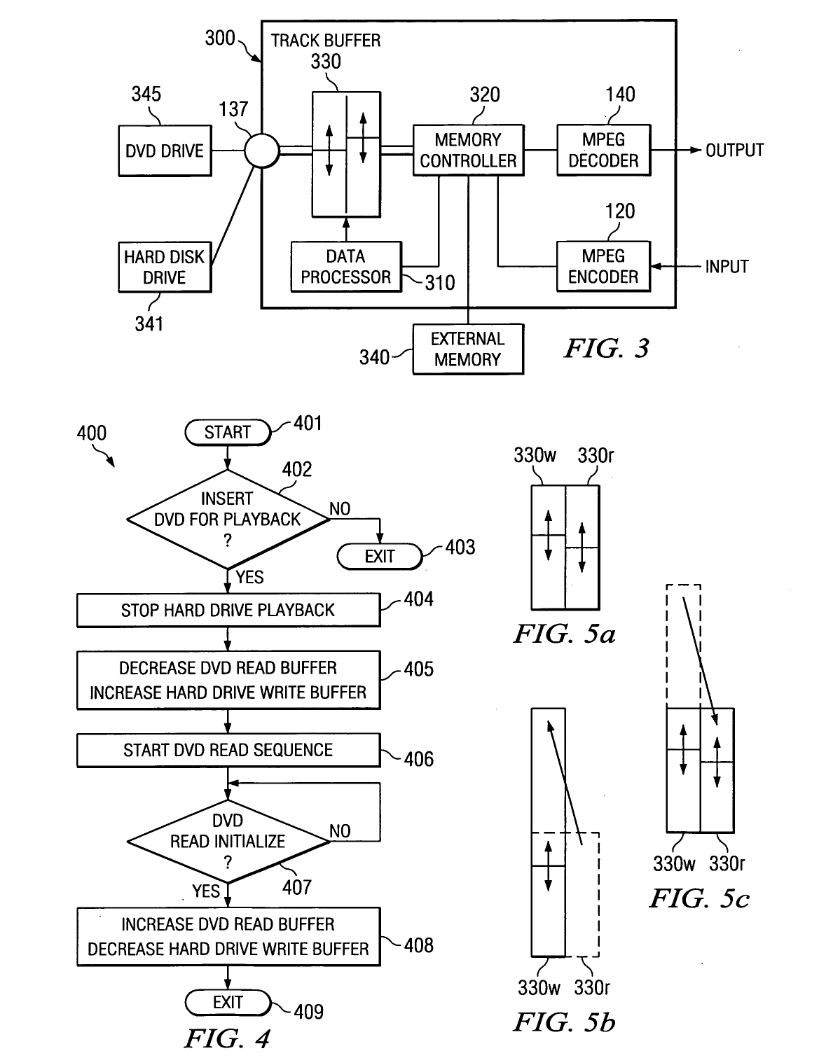

FIG. 3 illustrates an embodiment of this invention. MPEG codec LSI 300 includes MPEG encoder 120, MPEG decoder 140, data processor 310, memory controller 320, combined track buffer 330 and external memory. Hard disk driver 341 and DVD drive 345 connect to MPEG codec LSI via interface 137. MPEG codec LSI 300 is similar to MPEG codec LSI 100 illustrated in FIGS. 1 and 2 except for the track buffers. MPEG codec LSI 300 includes a single combined track buffer whose memory allocation is controlled by data processor 310 rather than the separate track buffers 131 and 135 of MPEG codec LSI 100. The manner of buffer allocation will be described below in conjunction with FIGS. 4 and 5.

FIG. 4 illustrates the sequence of this invention in response to insertion of a DVD into the DVD drive for playback. This is assumed to occur in the worst case when the hard disk drive is both reading and writing. Process 400 begins at start block 401. Process 400 checks to determine if a DVD is inserted for playback (decision block 402). Host processor 310 takes action before detection of command assertion or state transition to the DVD initial sequence by acting upon insertion of the disc for reading. If there in no disk insertion (No at decision block 402), then process 400 is not applicable and ends (exit block 403). If this is the case (Yes at decision block 402), then hard drive playback is stopped (processing block 404). It is assumed that insert of a DVD for playback means that the user no longer wants playback from hard disk drive 341.

Next process 400 changes the track buffer allocations (processing block 405). Host processor 310 decreases the size of the reading track buffer for the DVD to just enough for the initial sequence such as the first MKB detection. Host processor 319 allocates the freed memory to the write track buffer for the hard disk drive. This allocation prevents system breakdown caused bus occupancy due to the first MKB process if several storage devices are connected to a single ATA/ATAPI bus. Host processor 310 then starts the initial sequence mentioned for reading the DVD (processing block 406).

Process 400 tests to determine if the initial DVD drive reading initialization sequence is complete (decision block 407). Process 400 repeats this test if the DVD drive reading initialization sequence is not complete (No at decision block 407). Eventually the DVD read initialization sequence finishes (Yes at decision block 407). Host processor 310 restores the DVD read track buffer to its initial size and also reduces the size of the hard disk drive write track buffer by transferring data to the hard disk drive (processing block 408). This completes the track buffer reallocation (exit block 409).

FIGS. 5a, 5b and 5c illustrate the buffer allocations between write track buffer 330w and read track buffer 330r during process 400. FIG. 5a illustrates an initial buffer allocation with roughly equal amounts of memory allocated to write track buffer 330w and read track buffer 330r. FIG. 5b illustrates the result of processing block 405 reallocating memory from read track buffer 330r to write track buffer 330w. FIG. 5c illustrates the result of processing block 408 returning the buffer allocations to normal.

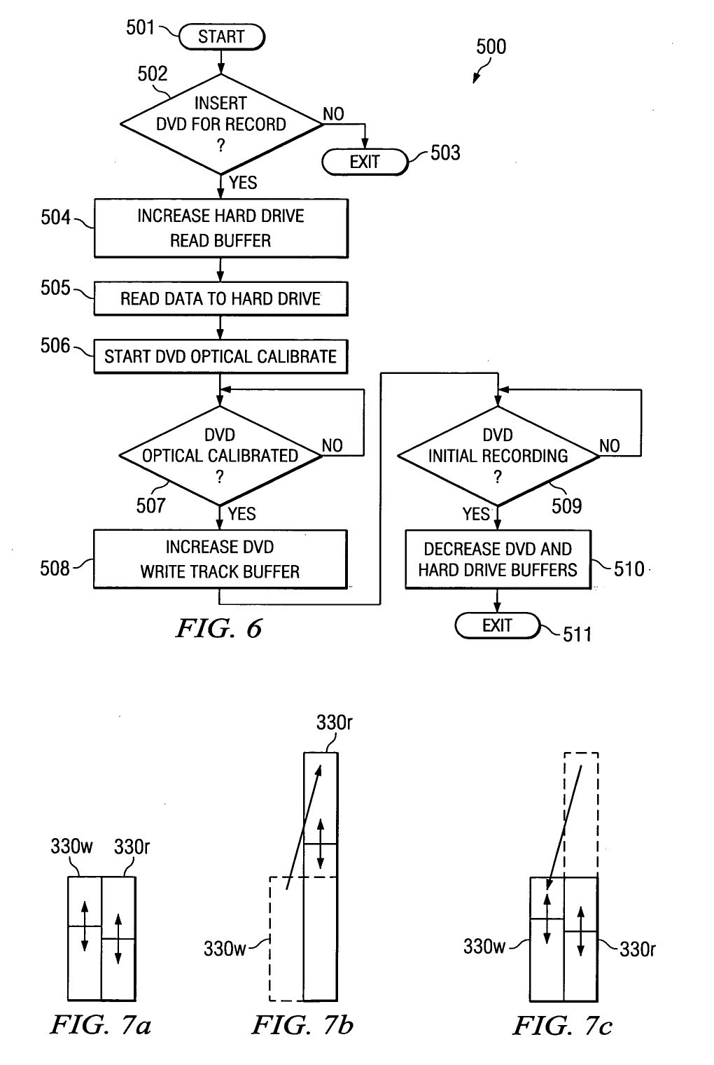

FIG. 6 illustrates process 500 which is an embodiment of this invention directed to DVD writing. This embodiment concerns a long waiting time in the writing sequence for recording to the DVD disc. The longest waiting time is the first DVD-R/DVD-RW writing process just after disc insertion. The optical laser power calibration that occurs after disk insertion and cache preparation for writing to the disc each requires 7 seconds for a total of 14 seconds. During this time data communication with a storage device is impossible.

Process 500 begins at start block 501. Process 500 first tests to determine if a DVD is inserted into the DVD drive for recording (decision block 502). If this is not the case (No at decision block 502), the process 500 is inapplicable and ends (exit block 503). If a DVD disk is inserted for recording (Yes at decision block 502), then process 500 increases the size of the read track buffer for the hard disk drive (processing block 505). This enables reading enough data from the hard disk drive to maintain smooth playback until the optical calibration finishes in approximately 7 seconds. Process 500 then reads data to the hard drive (processing block 505) and starts the DVD optical laser power calibration for recording (processing block 506).

Process 500 then tests to determine if the optical laser power calibration is complete (decision block 507). If not (No at processing block 507), then process 500 continues the test. After the optical laser power calibration completes (Yes at decision block 507), host processor 310 increases the size of the write track buffer to prepare for writing to the DVD (processing block 508). Because another 7 seconds waiting occurs, an amount of memory area is equivalent to 7 seconds is necessary.

Process 500 then checks to determine if DVD initial recording has begun (decision block 509). If not (No at processing block 509), then process 500 continues the test. After the first DVD recording begins (Yes at decision block 509), host processor 311 reduces the sizes of both the read track buffer and the write track to their values before this initial DVD write sequence (processing block 510). With this return to normal, process 500 ends (exit block 511).

FIGS. 7a, 7b and 7c illustrate the buffer allocations between write track buffer 330w and read track buffer 330r during process 500. FIG. 7a illustrates an initial buffer allocation with roughly equal amounts of memory allocated to write track buffer 330w and read track buffer 330r. FIG. 7b illustrates the result of processing block 504 reallocating memory from write track buffer 330w to read track buffer 330r. FIG. 7c illustrates the result of processing block 510 returning the buffer allocations to normal.

This invention teaches it is not necessary to provide a very large track buffer that includes redundant area. This invention reduces the redundant buffering area that is only used for specific cases such as disc insertion or the first reading or writing process. With the total track buffer size fixed, the host processor controls the amounts allocated to reading and writing. This method will be particularly effective in a system with a single ATA/ATAPI bus architecture.

1. A method for controlling a system that simultaneously processes video and audio data in real time having read and write track buffers for interfacing plural storage devices, comprising the steps of:
detecting a specific state at one of the storage devices that generates a long delay for communication; and
in response to detection of the specific state dynamically allocating a fixed amount of memory to the read and write track buffers.

2. The method of claim 1, wherein:
the plurality of storage devices includes a first storage device having a long delay caused by mechanical performance and a second storage device not having a long delay caused by mechanical performance.

3. The method of claim 2, wherein:
said step of detecting a specific state detects occurrence of mechanical performance that causes a long delay at the first storage device; and
said step of dynamically allocating memory to the read and write track buffers
increases the size of the write track buffer and decreases the size of the read track buffer if the second storage device is writing, and
increased the size of the read track buffer and decreases the size of the write track buffer if the second storage device is reading.

4. The method of claim 1, wherein:
said step of detecting a specific state detects insertion of a removable disk into a removable disk storage device for playback from the removable disk; and
said step of dynamically allocating memory to the read and write track buffers commands increases the size of the write track buffer and decreases the size of the read track buffer.

5. The method of claim 4, wherein:
said step of dynamically allocating memory to the read and write track buffers further includes
waiting for a read initiation interval at the removable disk storage device to pass,
thereafter transfer data in the write track buffer to a second storage device different from the removable disk storage device.

6. The method of claim 5, wherein:
said step of dynamically allocating memory to the read and write track buffers further includes following waiting for a read initiation interval to pass and transferring data in the write track buffer to the second storage device re-allocating the fixed amount of memory to the read and write track buffers in fixed initialization amounts.

7. The method of claim 1, wherein:
said step of detecting a specific state detects insertion of a removable disk into one of the storage devices for writing to the removable disk; and
said step of dynamically allocating memory to the read and write track buffers commands increases the size of the read track buffer and decreases the size of the write track buffer.

8. The method of claim 7, wherein:
said step of dynamically allocating memory to the read and write track buffers further includes
waiting for a record initiation interval to pass,
thereafter transfer the data in the read track buffer to the removable disk in the removable disk storage device.

9. The method of claim 8, wherein:
said step of dynamically allocating memory to the read and write track buffers further includes following waiting for the record initiation interval to pass and transferring data in the read track buffer to the removable disk in the removable disk storage device re-allocating the fixed amount of memory to the read and write track buffers in fixed initialization amounts.
